(19) United States
(12) Patent Application Publication
(10) Pub. No.: US 2021/0359300 A1
(43) Pub. Date: Nov. 18, 2021

(54) Alternative Method for Making Lithium Battery Cathode Materials

(71) Applicant: Nano One Materials Corp., Burnaby (CA)

(72) Inventor: Stephen A. Campbell, Burnaby (CA)

(73) Assignee: Nano One Materials Corp.

(21) Appl. No.: 17/109,831

(22) Filed: Dec. 2, 2020

Related U.S. Application Data
(60) Provisional application No. 63/024,641, filed on May 14, 2020.

(51) Int. Cl. H01M 4/505; H01M 4/525; H01M 10/0525; C01G 53/00

(52) U.S. Cl. CPC H01M 4/505; H01M 4/525; H01M 2004/028; C01G 53/54; C01G 53/50; H01M 10/0525

(57) ABSTRACT

The invention is related to a method of forming a lithium ion metal oxide and a battery comprising the lithium ion metal oxide. The method comprises reacting at least one metal in elemental form with carbox to form a metal carbox and heating the metal carbox to form said lithium ion metal oxide.

### CROSS-REFERENCE TO RELATED APPLICATIONS

This application claims priority to pending U.S. Provisional Application No. 63/024,641 filed May 14, 2020 which is incorporated herein by reference.

### FIELD OF THE INVENTION

The present invention is related to an improved method for making lithium ion metal oxide battery cathode materials. More specifically, the present invention is related to an improved method of making precursors which are calcined to form lithium ion metal oxides suitable for use as a battery cathode wherein the method of forming the precursor eliminates the necessity of intermediate reactants and decreases the amount of solvent required in the process.

### BACKGROUND

The state of the art method for manufacturing lithium battery cathode materials relies on transition metal carbonates as feedstocks. The transition metal carbonates are typically prepared from metal sulfates which increases cost and which has significant risk of supply chain inconsistencies due to various global issues. The process for forming Ni and Mn sulfate includes a metal powder stage as part of the purification wherein the metal powder is re-dissolved in sulfuric acid to make the pure metal sulfate solution. The metal sulfate is then crystallized as a hydrate. Formation of the carbonate from the sulfate has associated risk including sodium sulfate by-product which must be handled in large volumes.

One of the more promising cathode materials for batteries is an oxide comprising various ratios of nickel, manganese and cobalt, such as those referred to in the art as NMC's. NMC is generally represented by the chemical formula:

Li_{2-x-y-z}NiₓMn_{y}Co_{z}O₂

wherein x+y+z≤1; and wherein the formula is represented in stoichiometric balance with the understanding that the lithium is mobile and functions as the charge carrier into and out of the cathode as known in the art.

The process of forming lithium metal oxides includes the formation of a powder comprising salts of the metals followed by calcining of the powder to achieve the oxide in a crystallographic ordered lattice. The unit cells of the crystallographic ordered lattice comprise layers and the lithium can migrate into and out of the layers. There are two primary ways of forming the powder. The traditional approach is to intimately mix salts of the metals to form a homogeneous mixture. The homogenous mixture can be formed by many techniques including physical mixing of the solids, co-precipitation, sol-gel and the like, each of which is characterized by the formation of a mixture of metal salts with the choice of technique partially determined by the desired particle size and degree of homogeneity both of which are thought to impact the properties of the ultimate oxide even though quantification of the benefits is difficult to ascertain. Techniques which rely on the mixing of metal salts to form a powder, and preferably a homogenous powder, are characterized by the formation of an amorphous mixture of separate salts.

A modern technique has recently come to the fore as a significant improvement over the mere mixing of salts. The modern technique, referred to in the art as complexometric or complexecelle formation, forms ordered crystalline precursors of metal salts instead of an intimate mixture of powders. The complexometric method relies on carefully controlled precipitation conditions to precipitate an ordered precursor comprising salts of the metals ultimately incorporated in the lithium metal oxide. By way of a non-limiting example, a precursor for forming a lithium metal oxide with equal proportions of nickel, manganese and cobalt would be in the form of an ordered lattice comprising an equal molar concentration of a nickel salt, a manganese salt and a cobalt salt. While not limited to theory, it is hypothesized that by having an ordered lattice of metal salts, as opposed to a mixture of powdered metal salts, the metal migration during the calcining is more efficient thereby allowing the ordered lattice of oxides to have fewer dislocations, fewer crystalline impurities or fewer inactive phases even though this has proven difficult to quantify. Oxides formed from the precursor prepared by the complexometric method have proven to be advantageous with regards to their properties as a cathode in a battery.

The complexometric method, which relies on balancing the solubility of metal salts to precipitate the metal salts in an ordered lattice, requires copious amounts of water and therefore the cost of the process, though advantageous over solid state methods, complicates the manufacturing scale achievable within a reasonable space and with reasonable resources as the water must be removed prior to calcining. Removing large volumes of water is neither cost effective nor conducive to a large scale process. Furthermore, the process utilizes materials, such as ammonia or ammonium hydroxide, for pH control which increases the complexity in a manufacturing environment as the ammonia must be removed and either disposed of or recycled neither of which is conducive to environmental stewardship or effective manufacturing practice.

The present invention provides a direct route for the preparation of the metal precursor salt from elemental metal, such as metal oxalate, which does not require the sequential formation of the sulfate salt and carbonate salt and which can be accomplished utilizing minimal amounts of water.

### SUMMARY OF THE INVENTION

The present invention is related to an improved method for forming lithium ion metal oxides and particularly lithium ion metal oxides suitable for use as a lithium ion battery cathode material.

More specifically, the present invention is specific to an improved method of forming lithium ion metal oxides from elemental metal thereby eliminating intermediate products such as sulfates and carbonates.

A particular feature of the present invention is a reduction in the amount of solvent necessary to form the lithium ion metal oxides.

These, and other advantages, as will be realized are provided in a method of forming a lithium ion metal oxide. The method comprises reacting at least one metal in elemental form with carbox to form a metal carbox and heating the metal carbox to form said lithium ion metal oxide.

Yet another embodiment is provided in a method of forming a battery comprising:

forming a lithium ion metal oxide comprising:
reacting at least one metal in elemental form with carbox to form a metal carbox; and heating the metal carbox to form the lithium ion metal oxide;
forming a cathode comprising the lithium ion metal oxide; and
forming a battery comprising the cathode.

### DESCRIPTION

The present invention is related to an improved process for the manufacture of lithium ion metal cathode materials and particularly for the formation of precursors to lithium ion metal cathode materials. More specifically, the present invention is related to an improved process for the formation of precursors of lithium ion metal oxide comprising at least one metal salt selected from nickel, manganese, cobalt, aluminum and iron salts wherein the metal salt is calcined to form a lithium ion metal cathode material. Even more specifically, the present invention is related to a process for making precursors of lithium metal oxide wherein the formation of the precursor requires low solvent consumption and key reactants can be recycled.

The instant invention is an improvement in the art wherein a salt of a metal with an organic comprising multiple carboxylic acid groups is formed directly by the reaction of the appropriate acid with elemental metal thereby eliminating the formation of an intermediate metal carbonate or metal sulfate.

For the purposes of this disclosure the term carbox acid will be used to represent acids comprising multiple carboxylic acid groups. The term metal carbox will be used to represent salts of metals with an acid comprising multiple carboxylic acid groups.

In the inventive process powders of metal in their elemental form; particularly nickel, manganese and/or cobalt; are mixed with carbox acid, preferably in solvent, wherein the carbox acid is in a molar excess relative to the metal powder. The reaction is allowed to proceed, preferably with agitation, for a sufficient time to allow all of the elemental metal to be converted to metal carbox thereby forming a slurry comprising metal carbox in solvent. Agitation is preferred to increase the reaction rate. Li₂CO₃ is preferably added to react with the remaining carbox acid. The solvent is removed providing a dried slurry which comprises primarily the metal carbox as an oxide precursor. The oxide precursor is calcined at the optimum temperature and atmosphere to produce the finished single phase lithiated mixed oxide.

A particular feature of the invention is the ability to utilize slurries with high solids content. The amount of solvent in the slurry can be very low, less than 10 wt %, however, powder mobility is improved with additional solvent and the reaction rate is therefore increased. It is preferable to balance the mixing efficiency, which favors higher solvent content, with the requirement that the solvent must ultimately be removed, which favors lower or no solvent content. In a particularly preferred embodiment a slurry comprising 40-60 wt % solids, wherein the solids comprise primarily metal carbox, is a reasonable balance between powder mobility and the ability to dry the metal carbox powder in a reasonable amount of time using a reasonable amount of energy.

The cathode is formed from an oxide precursor comprising metal carbox salts wherein the metal carbox comprises at least one of Li, Ni, Mn, Co, Al or Fe as will be more fully described herein with Li, Ni, Mn and Co being preferred. The oxide precursor is calcined to form the cathode material as a lithium ion metal oxide.

Multi-carboxylic acids, or carbox acids, comprise at least two carboxyl groups. A particularly preferred multi-carboxylic acid is oxalic acid due, in part, to the minimization of carbon which must be removed during calcining. Other low molecular weight di-carboxylic acids can be used such as malonic acid, succinic acid, glutaric acid and adipic acid. Higher molecular weight di-carboxylic acids can be use, particularly with an even number of carbons which have a higher solubility, however the necessity of removing additional carbons and decreased solubility renders them less desirable. Other multi-carboxylic acids such as citric acid, lactic acid, oxaloacetic acid, fumaric acid, maleic acid and other polycarboxylic acids can be utilized with the proviso they have sufficient solubility to achieve at least a small stoichiometric excess and have sufficient chelating properties. It is preferable that acids with hydroxyl groups not be used due to their increased hygroscopic characteristics.

Upon completion of the reaction to form the metal carbox, the resulting slurry is dried to remove the solvent and to obtain the dried precursor powder comprising metal carbox. Any type of drying method and equipment can be used including spray dryers, tray dryers, freeze dryers and the like with the drying method and equipment chosen primarily based on manufacturing conveniences. The drying temperatures would be defined and limited by the equipment utilized with a preference for drying at less than 350° C. and more preferably 200-325° C. In an exemplary method for demonstrating the invention, drying can be done using an evaporator such that the slurry mixture is placed in a tray and the solvent is released as the temperature is increased. Any evaporator in industrial use can be employed. A particularly preferred method of drying at manufacturing scale is a spray dryer with a fluidized nozzle or a rotary atomizer. These nozzles are preferably the smallest size diameter suitable for the size of the oxide precursor in the slurry mixture. The drying medium is preferably air due to cost considerations.

The dried precursor powder, comprising primarily metal carbox, is transferred into the calcining system batch-wise or continuously such as by means of a conveyor belt. The calcining system may be a box furnace utilizing ceramic trays or saggers as containers, a rotary calciner, a fluidized bed, which may be co-current or counter-current, a rotary tube furnace and other similar equipment without limit thereto.

In one embodiment it is preferred that the molar ratios of metal carbox; specifically nickel carbox, manganese carbox, cobalt carbox and lithium carbox; be in a molar ratio sufficient to achieve the chemical formula consistent with a rock salt crystalline material which, after calcining, is represented by:

Li_{2-x-y-z}NiₓMn_{y}X_{z}O₂

wherein x+y+z≤1; and

### X is Al or Co.

More preferably, none of x, y or z are zero. In one embodiment, at least one of x, y or z is 0.2-0.5 and in a particularly preferred embodiment x, y and z are each between 0.23 and 0.43; more preferably between 0.3 and 0.36 and most preferably x, y and z are approximately equal. In another embodiment x is greater than at least one of y or x. In a particularly preferred embodiment x≥y+z. Particularly preferred rock salt crystalline materials are selected from LiNi_{0.30}Mn_{0.30}Co_{0.3002}, referred to in the art as NMC111; LiNi_{0.60}Mn_{0.20}Co_{0.20}O₂, referred to in the art as NMC622; and LiNi_{0.80}Mn_{0.10}Co_{0.10}O₂, referred to in the art as NMC811 wherein in each of the preferred formulations to molar ratio of each metal is listed as +0.01 mole. By way of example Ni_{0.30} refers to range Ni_{0.29} to Ni_{0.31}.

In one embodiment it is preferred that the molar ratios of metal carbox; specifically nickel carbox, manganese carbox, cobalt carbox and lithium carbox; be in a molar ratio sufficient to achieve the chemical formula, after calcining, represented by:

LiNiₓMn_{y}Co_{z}O₄

wherein x+y+z≤2 which is preferably in a crystalline form referred to in the art as a spinel. The lithium metal oxide has a metal to lithium ratio of nominally 2:1 thereby increasing the relative amount of excess lithium in the liquid component. In an embodiment z is 0. In an embodiment 0.5≤x≤0.6 and 1.4≤y≤1.5. In an embodiment 0.45≤x≤0.55 and 1.45≤y≤1.55.

Dopants can be added to enhance the properties of the oxide such as electronic conductivity and stability. The dopant is preferably a substitutional dopant added in concert with the primary nickel, manganese and optional cobalt. A substitutional dopant occupies a lattice site normally occupied by Ni, Mn or Co and therefore the relative arrangement of metal atoms in the lattice is not appreciable altered. The dopant preferably represents no more than 5 mole % of the total amount of metals in the oxide. Preferred dopants include Al, Gd, Ti, Zr, Mg, Ca, Sr, Ba, Mg, Cr, Cu, Fe, Zn, V and B with Al and Gd being particularly preferred. It is preferable that salts of the dopant be added to the slurry prior to drying. The salt is not limited herein however oxalates or carbonates are preferred for manufacturing conveniences.

When dopants are employed the ratios of metal carbox; specifically nickel carbox, manganese carbox, cobalt carbox and lithium carbox; and dopant salt are in a ratio sufficient to achieve the chemical formula, after calcining, represented by:

Li_{2-x-y-z}NiₓMn_{y}X_{z}GaO₂ Formula II

wherein x+y+z+a≤1 wherein

### X is Al or Co;

G is a dopant;
a≤0.05.

More preferably, none of x, y or z are zero. In a particularly preferred embodiment at least one of x, y or z is 0.2-0.5 and in a particularly preferred embodiment x, y and z are each between 0.23 and 0.43; more preferably between 0.3 and 0.36 and most preferably x, y and z are approximately equal. In another embodiment x is greater than at least one of y or x. In a particularly preferred embodiment x≥y+z. A particularly preferred embodiment is selected from the group constating of NMC111, NMC622 or NMC811 wherein Ni, Mn or Co is substituted by a dopant at the appropriate level.

In another embodiment, when dopants are employed the molar ratios of metal carbox; specifically nickel carbox, manganese carbox, cobalt carbox and lithium carbox; and dopant salt are in a molar ratio sufficient to achieve the chemical formula, after calcining after calcining, represented by:

LiNiₓMn_{y}Co_{z}EₐO₄ Formula I

wherein x+y+z+a≤2;
E is a dopant; and
a≤0.05. The lithium metal oxide has a metal to lithium ratio of nominally 2:1 thereby increasing the relative amount of excess lithium in the liquid component. In an embodiment z is 0. In an embodiment 0.5≤x≤0.6 and 1.4≤y≤1.5. In an embodiment 0.45≤x≤0.55 and 1.45≤y≤1.55.

Metal carbox can be formed by direct interaction of elemental metal with an acid, preferably with agitation such as in a bead mill, and preferably in the presence of a solvent. Elemental metal and carbox acid can be loaded into a bead mill in the desired stoichiometric ratio with glass beads. Water, an organic solvent or a mixture can be used as a solvent. The reaction process is preferable initiated at room temperature and is preferably carried out with cooling in the temperature range 18-39° C. while monitoring the course of the flow by sampling until the charged reagents for product formation are almost completely consumed, after which stirring and cooling are stopped. The slurry comprising the metal carbox as a reaction product would preferably be separated from the glass bead and filtered. The metal carbox would preferably be purified to remove traces of unreacted metal wherein the unreacted metal is subjected to a second process wherein the reaction with carbox is repeated. The filtrate could be returned to the second process thereby allowing excess carbox to react with the previously unreacted metal.

Water, ethyl cellosolve, butyl acetate, n-propyl alcohol, n-butyl alcohol, toluene, xylene and white spirit are suitable solvents for demonstration of the invention. Water is preferred due to cost considerations and manufacturing simplicity. Purified water, such as distilled water, filtered water or water having passed through an ion exchange to remove impurities is preferred.

In an exemplary method a vertical type bead mill, which is directly connected to the reflux condenser and forced cooling would be charged with the calculated amounts of glass beads, solvent, carbox and elemental metal. A cooling bath and mechanical stirring would preferably be employed. During the process, samples could be taken of the reaction mixture, in which the content of metal salt and residual amount of acid would be determined. The process is exothermic therefore cooling is preferred.

The lithium ion metal oxide powder obtained after the calcining step is a fine, ultrafine or nanosize powder that may not require additional crushing, grinding or milling as is currently done in conventional processing. Particles are relatively soft and not sintered as in conventional processing.

The final calcined lithium metal oxide powder is preferably characterized for surface area, particle size by electron microscopy, porosity, chemical analyses of the elements and also the performance tests required by the preferred specialized application.

The spray dried lithium metal oxide precursor, or metal carbox, is preferably very fine and nanosize.

A particular advantage of the present invention is the direct reaction of elemental metal to form metal carbox as opposed to acetates. Acetates function as a combustion fuel during subsequent calcining of the oxide precursor and additional oxygen is required for adequate combustion. Lower molecular weight multi-carboxylic acids, particularly lower molecular weight dicarboxylic acids, and more particularly oxalic acid, decompose at lower temperatures without the introduction of additional oxygen. The oxalates, for example, decompose at about 300° C., without additional oxygen, thereby allowing for more accurate control of the calcining temperature. This may allow for reduced firing temperatures thereby facilitating the formation of disordered Fd3̅m spinel crystalline structures with minimal impurity phase occurring as seen at high temperature.

The lithium ion metal oxide cathode material is optionally treated with a phosphate salt, XPO₄, wherein X is the atoms necessary to balance the charge and X may be a monovalent atom, a divalent atom or a trivalent with the understanding that combinations may be used as desired. It is particularly preferred that X be easily removed either by washing or vaporization after application. The phosphate salt is applied to the surface of the metal oxide wherein the phosphate moiety forms a MnPO₄ on the surface of the metal oxide, or bonded to the surface of the metal oxide. The manganese is preferably predominantly in the +3 oxidation state with preferably less than 10 mole % of the surface manganese being in the +2 oxidation state and the manganese is thereby stabilized against reduction to Mn²⁺ at the surface. The reaction liberates X which is removed by washing or vaporization. In preferred phosphates, X is selected from NH₄⁺, H⁺, Li⁺, Na⁺, and combinations thereof. Particularly preferred phosphates include (NH₄)₃PO₄, (NH₄)₂HPO₄, (NH₄)H₂PO₄, and H₃PO₄ due to the ease of removal of X after formation of the surface manganese phosphate. It is preferred that the native manganese oxide of the calcined oxide precursor be reacted with phosphate as opposed to an added manganese or other metal. Therefore, it is preferred that the added phosphate be relatively free of Mn and more preferably less than 1 wt % manganese. It is preferable that no Mn⁺² be added with the phosphate or after formation of the oxide. It is preferable that there be no separate manganese phosphate phase such as manganese phosphate as a distinct phase on the surface. It is preferable that the phosphate ligate the surface of the metal oxide.

The LiM₂O₄ is preferably in a spinel crystalline form with a preferred crystallite size of 1-5 μm. The LiMO₂ is preferably in a rock salt crystalline form with a preferred crystallite size of about 50-250 nm and more preferably about 150-200 nm.

Ball milling, such as in a vertical bead mill is suitable for forming the metal carbox of the instant invention. Alternatively, hand grinding with a mortar and pestle is also sufficient to demonstrate the invention as are other methods suitable for introduction of an carbox to a metal. The metals appear to self-passivate so grinding is preferred. Circulation through a ZrO₂ bead mill during formation of the metal carbox is an exemplary form of agitation for demonstration of the invention.

A modification of the spray dryer collector such that an outlet valve opens and closes as the spray dried metal carbox powder is transferred to the calciner can be implemented. Batchwise, the spray dried powder in the collector can be transferred into trays or saggers and moved into a calciner. A rotary calciner or fluidized bed calciner can be used to demonstrate the invention. The calcination temperature is determined by the composition of the powder and the final phase purity desired. For most oxide type powders, the calcination temperatures range from as low as 400° C. to slightly higher than 1000° C. After calcination, the powders are sieved as these are soft and not sintered. The calcined oxide does not require long milling times nor classifying to obtain narrow particle size distribution.

A battery could be formed as a coin cells for the purposes of demonstrating the invention. The method of forming a battery is well known to those of skill in the art and is not altered by the use of the inventive method described herein for forming the cathode material. A coin cell could preferably be assembled in an argon-filled glovebox. A conductive foil, such as a lithium foil could be used as a counter and reference electrodes in half-cells which is sufficient for testing of some aspects of the invention. Commercial eletrodes, such as Li₄Ti₅O₁₂ (LTO) composite electrodes could be used as counter and reference electrodes in full-cells. An electrolyte would be inserted between the anode and cathode with an exemplary electrolyte being an electrolyte such as 1 M LiPF₆ in 7:3 (vol %) ethylene carbonate (EC):diethylene carbonate (DEC). The electrodes could be separated such as by one or two 25 μm thick sheets of Celgard® membranes in half-cells, and one sheet of Celgard membrane full-cells.

### Electrode Preparations:

The composite electrodes were prepared by mixing the lithium metal oxide with 10 wt % conductive carbon black, as a conductive additive, 5 wt % polyvinylidene fluoride (PVDF), as a binder, dissolved in N-methyl-2-pyrrolidinone (NMP) solvent to form a slurry. The slurry was cast on graphite-coated aluminum foil and dried overnight at 60° C. under vacuum. Electrode disks with an average area of 1.54 cm² were cut from the electrode sheets with a typical loading of 4 mg/cm².

### Coin Cell Assembly:

Coin cells were assembled in an argon-filled glovebox. Lithium foil (340 μm) was used as counter and reference electrodes in half-cells, and graphite on copper foil was used as counter and reference electrodes in full-cells. 1 M LiPF₆ in 7:3 (vol %) ethylene carbonate (EC):diethylene carbonate (DEC) was used as the electrolyte. The electrodes were separated by one or two 25 μm thick sheets of Celgard® membranes in half-cells, and one sheet of Celgard membrane full-cells.

### Cycling Protocol:

The cathode cells incorporating a spinel were galvanostatically cycled in the voltage range of 3.5 V-4.9 V at various C-rates (1 C rate equivalent to 146 mAg⁻¹) at 25° C., using an Arbin Instrument battery tester (model number BT 2000). A constant voltage charging step at 4.9 V for 10 minutes was applied to the cells at the end of 1 C or higher rate galvanostatic charging steps. The cathode cells incorporating a rock salt NMC were galvanostatically cycled in the voltage range of 2.7 V-4.35 V at various C-rates (1 C rate equivalent to 200 mAg⁻¹) at 25° C. A constant voltage charging step at 4.35 V for 10 minutes was applied to the cells at the end of 1 C or higher rate galvanostatic charging step.

### Example 1: Preparation of LiNi_{0.5}Mn_{1.5}O₄ Spinel Cathode Powder

A dispersion was formed comprising 6.2926 g Li₂CO₃ (Alfa Aesar) and 56.2587 g oxalic acid dihydrate (Univar) in 150 ml deionized water. The dispersion was heated to 90° C. to dissolve the excess acid after the initial reaction. After cooling 5.0042 g of Ni powder (Alfa Aesar) and 14.0408 g of Mn powder (Alfa Aesar) were added to the solution. The mixture was covered, heated again to 90° C. and stirred for 22 hours. The final mixture was then evaporated to dryness while stirring at 60° C. and ground into a powder by mortar and pestle. The precursor powder obtained was then calcined in air, ramping the temperature from ambient to 900° C. at 5° C./minute holding for 15 hours and then air quenching to ambient. The produced powder was examined using X-ray diffraction (XRD) and found to be the pure phase of the expected spinel structure matching the pattern of the same material made with the prior art as represented in WO2018/132903.

The invention has been described with reference to the preferred embodiments without limit thereto. One of skill in the art would realize additional improvements and alterations which are not specifically set forth but are within the meets and bounds of the invention as more specifically set forth in the claims appended hereto.

Claimed is:

1. A method of forming a lithium ion metal oxide comprising:
reacting at least one metal in elemental form with carbox to form a metal carbox; and
heating said metal carbox to form said lithium ion metal oxide.

2. The method of forming a lithium ion metal oxide of claim 1 wherein said at least one metal is selected from the group consisting of Li, Ni, Mn, Co, Al, and Fe.

3. The method of forming a lithium ion metal oxide of claim 2 wherein said at least one metal is selected from the group consisting of Li, Ni, Mn and Co.

4. The method of forming a lithium ion metal oxide of claim 1 wherein said carbox comprises multiple carboxylic acid groups.

5. The method of forming a lithium ion metal oxide of claim 4 wherein said carbox is selected from the group consisting of oxalic acid, malonic acid, succinic acid, glutaric acid, adipic acid, citric acid, lactic acid, oxaloacetic acid, fumaric acid and maleic acid.

6. The method of forming a lithium ion metal oxide of claim 5 wherein said carbox is oxalic acid.

7. The method of forming a lithium ion metal oxide of claim 1 wherein said carbox does not comprise a hydroxyl group.

8. The method of forming a lithium ion metal oxide of claim 1 wherein said lithium ion metal oxide is defined by Formula I:
LiNiₓMn_{y}Co_{z}EₑO₄ Formula I
wherein E is a dopant;
x+y+z+e=2; and
0≤e≤0.2

9. The method of forming a lithium ion metal oxide of claim 8 wherein said Formula I is in a spinel crystalline form.

10. The method of forming a lithium ion metal oxide of claim 8 wherein neither x nor y are zero.

11. The method of forming a lithium ion metal oxide of claim 10 wherein said lithium ion metal oxide is LiNi_{0.5}Mn_{1.5}O₄.

12. The method of forming a lithium ion metal oxide of claim 8 wherein said lithium ion metal oxide is defined by the formula LiNiₓMn_{y}O₄ wherein 0.5≤x≤0.6 and 1.4≤y≤1.5.

13. The method of forming a lithium ion metal oxide of claim 12 wherein said 0.45≤x≤0.55 and 1.45≤y≤1.55.

14. The method of forming a lithium ion metal oxide of claim 8 wherein said lithium ion metal oxide has a molar ratio of Mn to Ni of no more than 3.

15. The method of forming a lithium ion metal oxide of claim 14 wherein said lithium ion metal oxide has a molar ratio of Mn to Ni of at least 2.33 to less than 3.

16. The method of forming a lithium ion metal oxide of claim 15 wherein said lithium ion metal oxide has a molar ratio of Mn to Ni of at least 2.64 to less than 3.

17. The method of forming a lithium ion metal oxide of claim 8 wherein said dopant is selected from the group consisting of Al, Gd, Ti, Zr, Mg, Ca, Sr, Ba, Mg, Cr Fe, Cu, Zn, V, Bi, Nb and B.

18. The method of forming a lithium ion metal oxide of claim 17 wherein said dopant is selected from the group consisting of Al and Gd.

19. The method of forming a lithium ion metal oxide of claim 1 wherein said lithium ion metal oxide is defined by the Formula II:
LiNiₐMn_{b}X_{c}G_{d}O₂ Formula II
wherein G is a dopant;
X is Co or Al;
wherein a+b+c+d=1; and
0≤d≤0.1.

20. The method of forming a lithium ion metal oxide of claim 19 wherein 0.5≤a≤0.9.

21. The method of forming a lithium ion metal oxide of claim 20 wherein 0.58≤a≤0.62 or 0.78≤a≤0.82.

22. The method of forming a lithium ion metal oxide of claim 19 wherein said Formula II is selected from the group consisting of LiNi_{0.30}Mn_{0.30}Co_{0.30}O₂, LiNi_{0.60}Mn_{0.20}Co_{0.20}O₂, and LiNi_{0.80}Mn_{0.10}Co_{0.10}O₂.

23. The method of forming a lithium ion metal oxide of claim 19 wherein said dopant is selected from the group consisting of Al, Gd, Ti, Zr, Mg, Ca, Sr, Ba, Mg, Cr Fe, Cu, Zn, V, Bi, Nb and B.

24. The method of forming a lithium ion metal oxide of claim 23 wherein said dopant is selected from the group consisting of Al and Gd.

25. The method of forming a lithium ion metal oxide of claim 1 wherein said heating is in air.

26. The method of forming a lithium ion metal oxide of claim 1 wherein said mixing is in a solvent.

27. The method of forming a lithium ion metal oxide of claim 26 wherein metal carbox is in a slurry comprising said solvent.

28. The method of forming a lithium ion metal oxide of claim 27 wherein slurry comprising 40-60 wt % of said metal carbox.

29. The method of forming a lithium ion metal oxide of claim 27 further comprising removing said solvent from said slurry thereby forming a dried powder of said metal carbox prior to said heating.

30. The method of forming a lithium ion metal oxide of claim 29 wherein said removing said solvent comprises drying in a dryer.

31. The method of forming a lithium ion metal oxide of claim 30 wherein said dryer is selected from the group consisting of a spray dryer, a tray dryer and a freeze dryer.

32. A method of forming a battery comprising:
forming a lithium ion metal oxide comprising:
reacting at least one metal in elemental form with carbox to form a metal carbox;
and
heating said metal carbox to form said lithium ion metal oxide;
forming a cathode comprising said lithium ion metal oxide; and
forming a battery comprising said cathode.

33. The method of forming a battery of claim 32 wherein said at least one metal is selected from the group consisting of Li, Ni, Mn, Co, Al, and Fe.

34. The method of forming a battery of claim 33 wherein said at least one metal is selected from the group consisting of Li, Ni, Mn and Co.

35. The method of forming a battery of claim 32 wherein said carbox comprises multiple carboxylic acid groups.

36. The method of forming a battery of claim 32 wherein said carbox is selected from the group consisting of oxalic acid, malonic acid, succinic acid, glutaric acid, adipic acid, citric acid, lactic acid, oxaloacetic acid, fumaric acid and maleic acid.

37. The method of forming a battery of claim 36 wherein said carbox is oxalic acid.

38. The method of forming a battery of claim 1 wherein said carbox does not comprise a hydroxyl group.

39. The method of forming a battery of claim 32 wherein said lithium ion metal oxide is defined by Formula I:
LiNiₓMn_{y}Co_{z}EₑO₄ Formula I
wherein E is a dopant;
x+y+z+e=2; and
0≤e≤0.2

40. The method of forming a battery of claim 39 wherein said Formula I is in a spinel crystalline form.

41. The method of forming a battery of claim 39 wherein neither x nor y are zero.

42. The method of forming a battery of claim 41 wherein said lithium ion metal oxide is LiNi_{0.5}Mn_{1.5}O₄.

43. The method of forming a battery of claim 39 wherein said lithium ion metal oxide is defined by the formula LiNiₓMn_{y}O₄ wherein 0.5≤x≤0.6 and 1.4≤y≤1.5.

44. The method of forming a battery of claim 43 wherein said 0.45≤x≤0.55 and 1.45≤y≤1.55.

45. The method of forming a battery of claim 39 wherein said lithium ion metal oxide has a molar ratio of Mn to Ni of no more than 3.

46. The method of forming a battery of claim 45 wherein said lithium ion metal oxide has a molar ratio of Mn to Ni of at least 2.33 to less than 3.

47. The method of forming a battery of claim 46 wherein said lithium ion metal oxide has a molar ratio of Mn to Ni of at least 2.64 to less than 3.

48. The method of forming a battery of claim 39 wherein said dopant is selected from the group consisting of Al, Gd, Ti, Zr, Mg, Ca, Sr, Ba, Mg, Cr Fe, Cu, Zn, V, Bi, Nb and B.

49. The method of forming a battery of claim 48 wherein said dopant is selected from the group consisting of Al and Gd.

50. The method of forming a battery of claim 32 wherein said lithium ion metal oxide is defined by the Formula II:
LiNiₐMn_{b}X_{c}G_{d}O₂ Formula II
wherein G is a dopant;
X is Co or Al;
wherein a+b+c+d=1; and
0≤d≤0.1.

51. The method of forming a battery of claim 50 wherein 0.5≤a≤0.9.

52. The method of forming a battery of claim 51 wherein 0.58≤a≤0.62 or 0.78≤a≤0.82.

53. The method of forming a battery of claim 50 wherein said Formula II is selected from the group consisting of LiNi_{0.30}Mn_{0.30}Co_{0.30}O₂, LiNi_{0.60}Mn_{0.20}Co_{0.20}O₂, and LiNi_{0.80}Mn_{0.10}Co_{0.10}O₂.

54. The method of forming a battery of claim 50 wherein said dopant is selected from the group consisting of Al, Gd, Ti, Zr, Mg, Ca, Sr, Ba, Mg, Cr Fe, Cu, Zn, V, Bi, Nb and B.

55. The method of forming a battery of claim 54 wherein said dopant is selected from the group consisting of Al and Gd.

56. The method of forming a battery of claim 32 wherein said heating is in air.

57. The method of forming a battery of claim 32 wherein said mixing is in a solvent.

58. The method of forming a battery of claim 57 wherein metal carbox is in a slurry comprising said solvent.

59. The method of forming a battery of claim 58 wherein slurry comprising 40-60 wt % of said metal carbox.

60. The method of forming a battery of claim 58 further comprising removing said solvent from said slurry thereby forming a dried powder of said metal carbox prior to said heating.

61. The method of forming a battery of claim 60 wherein said removing said solvent comprises drying in a dryer.

62. The method of forming a battery of claim 61 wherein said dryer is selected from the group consisting of a spray dryer, a tray dryer and a freeze dryer.
